(19) United States
(12) Patent Application Publication
(10) Pub. No.: US 2018/0356844 A1
(43) Pub. Date: Dec. 13, 2018

(54) PRESSURE-MAINTAINING AND REGULATING VALVE

(71) Applicant: Holger Blum, Teufen (CH)

(72) Inventor: Holger Blum, Teufen (CH)

(21) Appl. No.: 15/774,991

(22) PCT Filed: Nov. 11, 2016
(86) PCT No.: PCT/EP2016/077428

§ 371 Date: May 9, 2018

(30) Foreign Application Priority Data
Nov. 11, 2015 (DE) 20 2015 106 096.3

(51) Int. Cl. G05D 16/06

(52) U.S. Cl. CPC G05D 16/0655; G05D 16/0608

(57) ABSTRACT

Pressure holding and regulating valve characterized by a cylindrical valve housing (1) with an upper side (2), in which a central inlet bore (3) is provided with a diameter d1, and with a lower side (4), in which an inner bore (5) is, whose diameter d2 is greater than that of the diameter of the inlet bore (3) and which forms an outlet of the pressure holding and regulating valve, a closure piston (8) with an upper part (9) whose diameter d3 smaller than the diameter d2 of the inner bore (5) and larger than the diameter d1 of the inlet bore (3) is a freely movable, circular sealing disc (7) made of an elastomer between the closure piston (8) and an inner sealing surface (6) between the inner bore (5) and the inlet bore (3) on an inner side of the valve housing (1) is formed, and by a compression spring (12) which is supported in the inner bore (5) and presses trough the closure piston (8) the sealing washer (7) against the inner sealing surface (6).

The invention relates to a pressure holding and regulating valve.

EP 0 759 132 A1 discloses a pressure holding valve in which a displaceable valve piston is pressed against the upper side of a housing valve seat, to the underside of which the housing inlet channel leads and at the top thereof the housing outlet channel connects, and in which a separation membrane is arranged between the valve piston and an adjustable compression spring acting on it, which separation membrane is tightly clamped between the valve housing containing the valve piston and a spring mandrel containing the compression spring. In the valve housing space above the valve seat a valve piston guide disc is arranged slidably leading guide the valve piston, which disc forms together with the cylindrical guide shaft of the valve piston a narrow annular gap extending over the entire shaft circumference and sealingly covers up to this annular gap the underside of the diaphragm against the passage valve seat top connected to the housing outlet wherein the radial width of the annular gap is dimensioned at most so large that the annular gap can be traversed by the medium, depending on its viscosity, only with a slowed-down flow effectively damped by the throttling effect.

Conventional pressure holding valves, such as the valve of EP 0 759 132 A1, fail after a short time due to the tight material fits when the medium contains smallest amounts of suspended solids or when the fluid is a readily decomposable and/or polymerizing mixture, which is the case in particular with acrolein, which is processed in plants in which an intermediate product formed in a precursor stage is conveyed by a pump into a vacuum column.

Liquid crude acrolein stabilized with phenolic inhibitors tends to an accelerated deposition of polymerization products even when it is rubbed between metallic moving surfaces.

This is the case when acrolein is passed through regulating valves having metallic closing contact surfaces. Such regulating valves are used in plants for the pure recovery of acrolein by vacuum distillation. As a result, the trouble-free operating time of such process equipment is often only a few weeks. Since acrolein is a poisonous, highly tear-irritating hazardous substance, the maintenance of disturbed plants that process acrolein is associated with cumbersome and lengthy and therefore costly operations.

The invention has for its object to provide a pressure holding and regulating valve, which has a long life, even when media are conveyed, containing solid constituents or tend to develop solid constituents in the passage through a plant.

For this purpose, the pressure holding and regulating valve according to the invention is characterized by a cylindrical valve housing having an upper side, in which a central inlet bore is provided with a diameter d1, and with a bottom side, in which an inner bore is provided, whose diameter d2 is greater than that of the diameter of the inlet bore and forms an outlet of the pressure holding and a regulating valve, a closure piston with an upper part whose diameter d3 is smaller than the diameter of the inner bore and larger than the diameter of the inlet bore, a freely movable, circular sealing disc made of an elastomer between the closure piston and an inner sealing surface which is formed between the inner bore and the inlet bore on an inner side of the valve housing, and by a compression spring which is supported in the inner bore and presses the sealing disc against the inner sealing surface via the closure piston.

In contrast to the conventional pressure holding valve of EP 0 759 132 A1, which contains many accurately fitted and therefore fault-prone items, the device according to the invention contains only two freely movable parts and a floating one, i.e. the freely moving elastomer seal which can be easily replaced just like the freely moving parts without the use of special tools.

The pressure holding and regulating valve according to the invention is largely insensitive to the presence of suspended solids in the flowing medium.

The pressure holding and regulating valve according to the invention has a self-cleaning effect, because, since all moving parts can move freely axially and laterally, deposits or accumulations of suspended solids are always flushed out with the fluid.

Therefore, the use of the pressure holding and regulating valve according to the invention is particularly advantageous if the pumped medium excretes insoluble by polymerization solids.

According to an advantageous embodiment, the pressure holding and regulating valve according to the invention is characterized in that the sealing disc has a diameter d3 which is greater than the diameter of the inlet bore plus the radial extent of the inner sealing surface, and which is smaller than the diameter of the upper part of the closure pistons.

These dimensions of the sealing disc ensures in an advantageous manner that the sealing disc covers the inlet bore in any case, regardless of the lateral position of the sealing disc relative to the inlet bore.

According to a further advantageous embodiment, the pressure holding and regulating valve according to the invention is characterized in that a gap formed between the upper part of the closure piston and the inner bore has a cross-sectional area which corresponds to the cross-sectional area of the inlet bore. This advantageously ensures that there is no bottleneck in the pressure holding and regulating valve for the flow of the medium to be delivered.

According to a further advantageous embodiment, the pressure holding and regulating valve according to the invention is characterized in that the top and the bottom of the valve housing are formed as planar sealing surfaces. Thus, the top and bottom can be used in an advantageous manner when installing the pressure holding and regulating valve as sealing surfaces against connection components.

According to a further advantageous embodiment, the pressure holding and regulating valve according to the invention is characterized in that the compression spring is supported by a Seeger ring arranged in the inner bore over a groove in the inner bore. Such a holder for the compression spring has the advantage that the compression spring can be easily and quickly replaced if necessary.

According to a further advantageous embodiment, the pressure holding and regulating valve according to the invention is characterized in that between the Seeger ring and the compression spring at least one clamping ring is arranged for adjusting the bias of the compression spring. The clamping rings are advantageously a simple means to change the bias of the compression spring to adjust the spring force acting on the gasket to the respective needs.

According to a further advantageous embodiment, the pressure holding and regulating valve according to the invention is characterized in that the valve housing and the closure piston are made of metal. Due to the dimensioning of the components of the pressure holding and regulating valve according to the invention, the valve housing and the closure piston can be made of metal, without this adversely affecting the formation of deposits in the medium to be delivered.

Further advantages, features and possible applications of the present invention will become apparent from the following description in conjunction with the embodiments illustrated in the drawings.

In the description, the claims and the drawing, the terms and associated reference numerals used in the list of reference numerals below are used.

In the drawings:

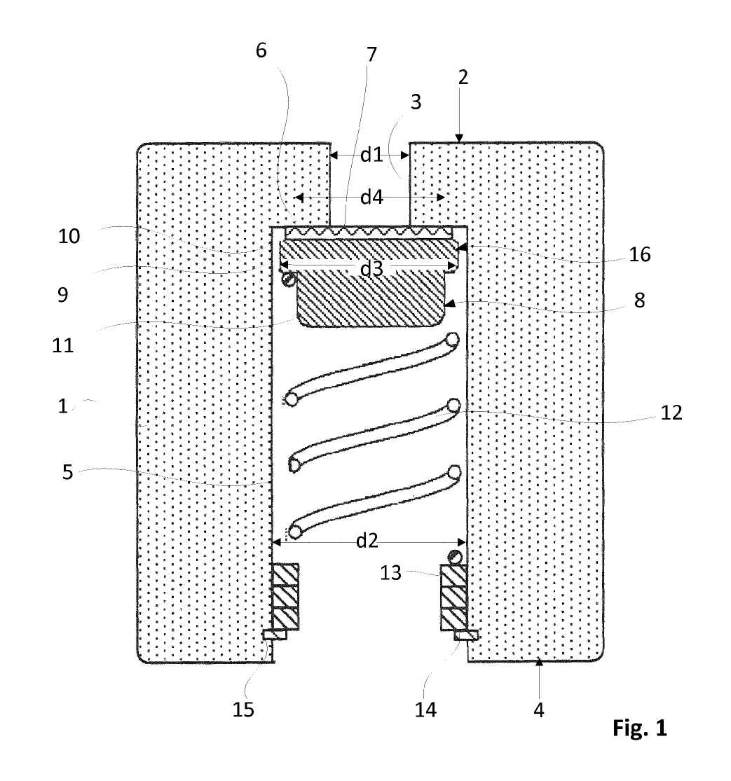

FIG. 1 shows a section through an embodiment of the pressure holding and regulating valve according to the invention, and

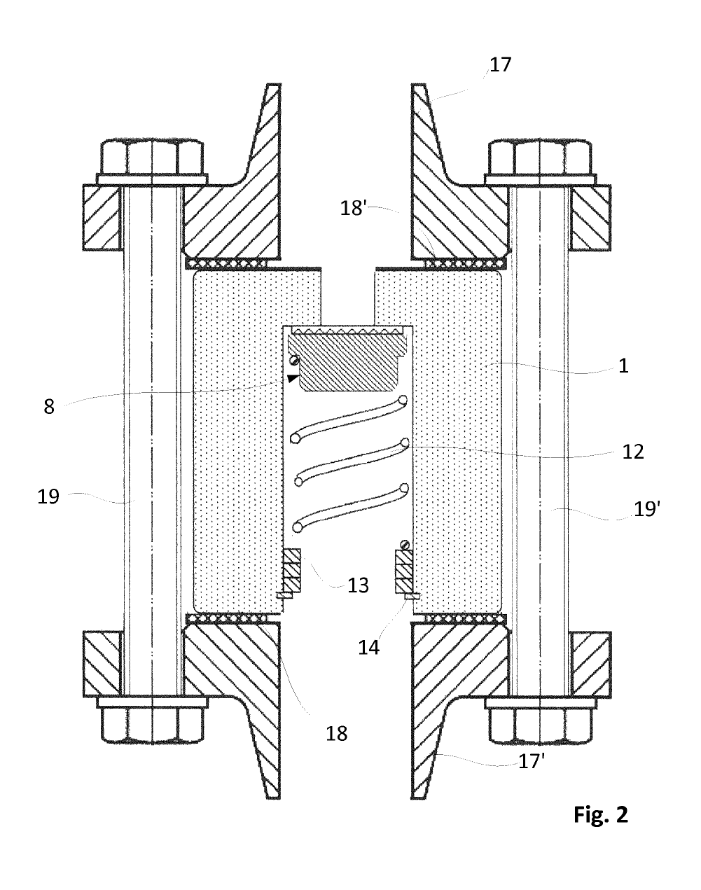

FIG. 2 shows a section through an installation of the pressure holding and regulating valve according to the invention in a process plant.

According to FIG. 1, the pressure holding and regulating valve according to the invention has a cylindrical, metallic valve housing 1 with a top side 2, in which a central inlet bore 3 with a diameter d1 is located.

The valve housing 1 comprises an inner bore 5, the diameter d2 is greater than that of the diameter of the inlet bore 3 and forms an outlet of the pressure holding and regulating valve.

The valve housing 1 has an underside 4, which, like the upper side 2, is designed as a planar surface and thus can be used as sealing surfaces against connecting components during installation of the pressure retaining and regulating valve.

In the valve housing 1 there is a cylindrical, planar, inner sealing surface 6 between the inner bore 5 and the inlet bore 3 as a transition between the inner bore 5 and the inlet bore. 3 A freely movable, circular sealing disk 7 made of an elastomer is arranged between a closure piston 8 and the sealing surface 6. As FIG. 1 shows, the diameter d3 of a cylindrical upper part 9 of the closure piston 8 is smaller than the diameter of the inner bore 5 but larger than the diameter of the inlet bore 3.

The sealing disk 7 has a diameter d3 which is greater than the diameter of the inlet bore plus the radial extend of the sealing surface 6. In addition, the diameter d3 of the sealing disk 7 is smaller than the diameter of the upper part 9 of the closure piston 8. The sealing disc 7 thus closes the inlet bore 3 independently of the lateral position of the sealing disc 7 when the closure piston 8 presses the sealing disc 7 against the sealing surface 6. The closure piston 8 has rounded edges 10. A cylindrical lower part 11 of the closure pistons 8 has a smaller diameter d4 than the inner diameter of a compression spring 12, which presses the closure piston 8 via the sealing disc 7 against the sealing surface 6.

The compression spring 12 has free passage gaps between the turns. The outer diameter of the compression spring 12 is smaller than the diameter d2 of the inner bore 5. The compression spring 12 is biased by one or more clamping rings 13. The clamping rings 13 sit with a h6-fit in the inner bore 5, which has a H7-fit. A Seeger ring 14, for example, a Seeger ring according to DIN 472, which is clamped in a groove 15, keeps the clamping rings 13 under pressure by being pressed against the compression spring 12. In the installed state, the compression spring 12 exerts a force on the sealing disk 7 by pre-stressing by means of the closure piston 8, whereby the inlet bore 3 is closed in a liquid-tight manner.

The compressive force of compression spring 12 is calculated in terms of spring constant times compression in mm according to the following formula:

$$Spring constant ( N \text{/} mm ) = \frac{material constant ( N \text{/} {mm}^{2} ) * {( diameter of spring in mm )}^{4}}{Number of turns * {( diameter of spring in mm )}^{3}}$$

As can be seen, there are several free variables to achieve the desired spring tension. The hydraulic pressure of the inflowing liquid at the inlet bore 3 causes that the sealing disc 7 lifts off from the plane inner sealing surface 6 against the spring force of the compression spring 12 and that liquid flow entering the inlet bore 3 can flow past the closure piston 8, through a gap 16 between the upper part of the closure piston 8 and the inner bore 5 and between the turns of the compression spring 12 into the inner bore 5.

A gap 16, which is formed between the upper part 9 of the closure pistons 8 and the inner bore 5, has a cross-sectional area which corresponds to the cross-sectional area of the inlet bore 3. During operation of the pressure holding and regulating valve according to the invention, only the spring 12 and the closure piston 8 are moving. The sealing disc 7 remains between the closure piston 8 and the sealing surface 6.

The compression spring 12, the closure piston 8 and the sealing disc 7 can move radially in the outlet bore 5 and position themselves, as experiments show, in free play centric position in the inner bore 5, when the pressure holding and regulating valve according to the invention is moved during operation. Therefore, the pressure holding and regulating valve according to the invention can be advantageously used, for example, on seagoing vessels, where the ordinate axis performs a wobbling motion due to the waves.

The pressure holding and regulating valve according to FIG. 1 can be installed between two DIN flanges 17, 17′ using flat gaskets 18 as shown in FIG. 2. If the flanges 17, 17′ are parts of two shut-off valves, the pressure holding and regulating valve according to the invention can be easily be replaced during operation by locking both valves above and below the pressure holding and regulating valve of FIG. 1 and by loosening bolts 19, 19′. The removed pressure holding and regulating valve is disassembled by relaxing the Seeger rings 14 and another compression spring 12 or an additional clamping ring 13 or more additional clamping rings can be used or replaced in a short time.

### LIST OF REFERENCE NUMBERS

1 Valve Housing
2 Upper Side
3 Inlet Bore
4 Lower Side
5 Inner Bore
6 Sealing Surface
7 Sealing Disk
8 Closure Piston
9 Upper Part Closure piston
10 Peripheral Edges
11 Lower Part Closure Piston
12 Compression Spring
13 Clamping Ring
14 Seeger Ring
15 Groove for Seeger Ring
16 Gap
17 Flange
17′ Flange
18 Flange Gasket
18′ Flange Gasket
19 Screw bolt
19′ Screw Bolt

1. Pressure holding and regulating valve characterized by:
a cylindrical valve housing (1) having an upper side (2), in which a central inlet bore (3) is provided with a diameter d1, and with a lower side (4), in which an inner bore (5) is provided, whose diameter d2 is greater than that of the diameter of the inlet bore (3) and which forms an outlet of the pressure holding and regulating valve,
a closure piston (8) with an upper part (9) whose diameter d3 is smaller than the diameter d2 of the inner bore (5) and greater than the diameter d1 of the inlet bore (3), a freely movable, circular sealing disc (7) made of an elastomer between the closure piston (8) and an inner sealing surface (6) between the inner bore (5) and the inlet bore (3) is formed on an inner side of the valve housing (1), and by
a compression spring (12) which is supported in the inner bore (5) and via the V closure piston (8) presses the sealing washer (7) against the inner sealing surface (6).

2. Pressure holding and regulating valve according to claim 1, characterized in that the sealing disc (7) has a diameter d4 which is greater than the diameter d1 of the inlet bore (3) plus the radial extent of the inner sealing surface (6), and is smaller than the diameter d3 of an upper part (9) of the closure piston (8).

3. Pressure holding and regulating valve according to claim 1, characterized in that the upper side (2) and the lower side (4) of the valve housing (1) are designed as planar sealing surfaces.

4. Pressure holding and regulating valve according to claim 1, characterized in that between the upper part (9) of the closure piston (8) and the inner bore (5) formed gap (16) has a cross-sectional area corresponding to the cross-sectional area of the inlet bore (3).

5. Pressure holding and regulating valve according to claim 1, characterized in that the compression spring (12) is supported by a Seeger ring (14) arranged in the inner bore (5) over a groove (15) in the inner bore (5).

6. Pressure holding and regulating valve according to claim 5, characterized in that between the Seeger ring (14) and the compression spring (12) at least one clamping ring (13) is arranged for adjusting the bias of the compression spring (12).

7. Pressure holding and regulating valve according to claim 1, characterized in that the valve housing (1) and the closure piston (8) are made of metal.
